(19) United States
(12) Patent Application Publication
(10) Pub. No.: US 2025/0250799 A1
(43) Pub. Date: Aug. 7, 2025

(54) CLAMP AND METHOD OF USE

(71) Applicant: Provis Pty Ltd, Wangaratta (AU)

(72) Inventors: Michael Harris, Wangaratta (AU); Spencer Ewenson, Wangaratta (AU)

(21) Appl. No.: 19/046,939

(22) Filed: Feb. 6, 2025

(30) Foreign Application Priority Data
Feb. 6, 2024 (AU) 2024900268

(51) Int. Cl. E04F 10/02; F16B 2/06

(52) U.S. Cl. CPC E04F 10/02; F16B 2/065

(57) ABSTRACT

The invention relates to a clamp for removably retaining a cross-member of a retractable shade, the clamp having a clamp body comprising at least one curved arm, and at least one opposing curved arm which is articulated relative to the clamp body, and a recess for releasably retaining a connector, and an adjuster for applying clamping force between the at least one curved arm and the at least one opposing curved to clamp the cross member and anchor the connector to the cross member.

### FIELD OF INVENTION

The present invention relates to the field of clamps, in particular clamps that are removably attachable to pulley blocks and other hardware components.

In one form, the invention relates to a clamp that is suitable for use with telescopic roman shades or canopies of the type used to protect swimming pools or outdoor recreational areas. In particular, the invention relates to a clamp used in the connection of roman shades to a pulley system for extending and retracting the roman shades.

It will be convenient to hereinafter describe the invention in relation to a clamp that is suitable for attaching a hardware component to telescopic roman shades of the type used to protect swimming pools or outdoor recreational areas, however it should be appreciated that the present invention is not limited to that use only.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Roman shades can be stationary or retractable. Retractable roman shades comprise one or more pieces of fabric attached to one or more cable-and-pulley systems which are operated to cause the fabric to retract in a telescopic manner. The cable is threaded through individual pulleys attached to elongate cross-members that are located periodically along the length of the fabric. The elongate cross-members are typically aluminium poles, aluminium pipes or channels that are connected to the fabric. The cross-members may be connected by being stitched into channels, sleeves or tapes along the fabric, thus fully enclosing the cross-member. Alternatively, the cross-member may be exposed with the fabric being attached to the underside by rivets or other fixing members. In a particularly preferred embodiment, sleeves are formed in the fabric into which the cross members are slid. Each end of the cross member may be secured at either end to prevent the fabric from working back to reveal the cross members, but generally the fabric is secured by rivets, screws or clamps or by the fabric being clamped with a cross member.

The shade is typically operated either manually or by a motorised system, both methods of operation relying on a looped cord (such as a polyester cord) which is attached to the ‘lead’ or ‘extending’ cross member. When extending the shade, the cord is pulled in a first direction to cause a corresponding part of the shade to move to a desired position, then the cord is tied off, locking the lead cross member in position. Often the other end of the shade is fixed to a rigid structure, hence the shade fabric tightens as it is extended and approaches full extension. To retract or ‘stack’ the shade, the cord is pulled in a second, opposite direction, causing the lead cross member to move in the opposite direction, such that the cross members are progressively stacked up against the supporting structure.

Roman shades for protecting swimming pools or outdoor recreational areas are typically mounted horizontally, extending from a fixed structure such as a wall or rigid posts, or moving within the perimeter of a fixed structure such as a pergola.

An important part of roman shades is the system for connecting the pulleys to the cross-members. Some systems comprise a stainless steel saddle (wire eye strap) riveted to the cross-member, the rivets necessarily piercing the material if the cross-member is stitched into a material channel. The steel saddle is then connected to the pulley either directly, or via a carabiner, closed ring or similar device.

Other systems use a metal clamp comprising two parts that encircle the cross-member and are held together by a tightened screw/s or locking pin/s. The metal clamp is then connected to the pulley either directly, or via a carabiner, closed ring or similar device.

However, there are difficulties associated with the prior art systems for connection of the pulley to the cross-member and material. Rivets or prior art 2-piece metal clamps tend to damage the comparatively soft fabric fibres when the shade material moves during extension and retraction, or moves in the wind, causing holes and tears in the fabric. The use of rivets also reduces structural integrity of the cross-members. The rivets are also permanent attachment points, the location of which cannot be altered without inflicting further damage on the material and cross member. Concomitantly, these types of roman shades are usually limited to factory production and are not suitable for DIY assembly.

Some prior art systems for connection do not use pulleys but rely on simple carabiner-type hooks that drag along the length of the cable. However, these systems are noisy to operate, they require a user to impart substantial pulling force on the cord when extending and retracting the shade, and over time the carabiner hook and cable can suffer extensive wear and damage.

Some prior art systems for connection are adapted to cope with the longitudinal force exerted in the direction of the cables, but cope poorly with transverse forces, such as those imparted when the wind blows across the roman shade, or when the shade does not retract/extend perfectly linearly.

Accordingly, there is a need for improved connection of the pulley or similar hardware items to a roman shade.

### SUMMARY OF INVENTION

An object of the present invention is to provide a connection between retractable shades such as roman shades and the retraction system, such as a pulley system.

Another objective of the present invention is to provide a connection that is easier to include into the assembly of a retractable shade system while allowing the shade to move and function effectively.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided an adjustable clamp adapted for anchoring a connector, the clamp comprising a clamp body and opposed curved arms, at least one of the curved arms being articulated relative to the clamp body.

Preferably the clamp has a first curved arm and a second, opposed articulated curved arm that can move towards or away from the first arm, such as by rotating about a pivot. Alternatively, the claim may have two curved arms and a third, opposed articulated curved arm that can move towards or away from the other two arms.

Preferably the clamp body comprises a recess adapted to receive and releasably retain at least part of a connector.

In another aspect of embodiments described herein there is provided a clamp for removably retaining a cross-member of a retractable shade, the clamp comprising;
a clamp body comprising at least one curved arm, and at least one opposing curved arm which is articulated relative to the clamp body, and a recess for receiving a connector, and
an adjuster for applying clamping force between the at least one curved arm and the opposing curved arm to clamp the cross member and anchor the connector to the cross member.

Preferably the clamp body includes first and second (anterior) clamp arms that are integral with the clamp body, and the single articulated arm is posterior to the two anterior arms. This arrangement of single and dual arms is advantageous for use of the clamp with roman shades because it allows neat stacking of adjacent cross-members and clamps when the roman shade is retracted. It also provides stabilisation such that the clamp provides a stable attachment point that is less susceptible to moving over time.

Preferably, the clamp body is generally rectangular in shape, and encloses or defines a generally rectangular conduit, although other conduit shapes may also be suitable. The clamp body comprises external faces and one or more an internal faces defining the conduit which has a longitudinal axis in a first direction through the clamp body. The clamp body may further include two ports in opposing sides of the rectangular body which are adapted for receiving either ends of an adjuster, such as a screw or locking pin. The screw or locking pin has a longitudinal axis in a second direction, preferably perpendicular to the first direction.

The adjuster for applying clamping force may take any convenient form. In a particularly preferred embodiment, the adjuster is a screw, bolt, clevis pin or locking pin, either end of which is located in the respective ports so that the body of the screw, bolt, clevis pin or locking pin traverses the conduit. The adjuster can be tightened against the body to apply the clamping force. The adjuster also anchors the connector in the clamp.

The connector may be directly anchored to the clamp, or indirectly anchored to the clamp. The connector may be for example, a pulley for connecting to the cable, or a shackle, such as a Y-shackle or D-shackle for connection to either the cord, cable components or some other part of the sail system. Other suitable connectors will be readily apparent to those skilled in the art and may include for example, a snap hook or scaff hook.

Preferably, when the connector is a pulley, the screw or locking pin passes through part of the pulley, directly anchoring the pulley in position yet still allowing a desired degree of movement. Specifically, the pulley may be anchored in the clamp, yet the pulley can still sway side to side, moving transversely relative to the pulley cable of the roman shade as the shade moves in the wind. Although anchored, the pulley can still move as designed, to swivel and move slightly left or right (slightly transversely relative to the cord) if the shade does not retract in a perfectly straight line. In another embodiment, the pulley attaches to the clamp at a solid mounting point, such as a channel in the clamp body or clamp surface.

In an alternative embodiment, the clamp of the present invention is indirectly attached to the pulley. For example, the screw or locking pin can pass through a pin or shackle that connects to the pulley, indirectly anchoring the pulley in position yet still allowing a desired degree of movement.

In another alternative embodiment, the connector is a Y-shackle receives the screw or locking pin of the clamp. The Y-shackle would typically connect the clamp to a stacking structure, or a fork terminal head at the stacking end, or forming a tie off point of the cord in the centre of the lead cross member.

In another aspect of embodiments described herein there is provided a clamp for retaining the cross-member of a retractable shade, the clamp comprising;
a clamp body comprising two integral anterior curved arms, and an articulated posterior arm, the clamp body defining a conduit for receiving at least part of a connector, and
a screw or locking pin for applying clamping force between the anterior and posterior arm, the screw or locking pin passing through the clamp body, through at least part of the connector and traversing the conduit.

As previously mentioned, preferably the adjuster passes through the connector, anchoring it to the clamp. In a particularly preferred embodiment, the anchor comprises a screw or locking pin passing through a pulley. Typically, the pulley comprises a rod, peg, bracket or pin which can be located in the conduit in the clamp body, the screw or locking pin passing transversely through a recess in the pin. The pin may be fixed and integral with the pulley or articulated relative to the pulley.

In another aspect described herein there is provided a pulley system for a roman shade, the system comprising;
a series of pulleys, each pulley being respectively anchored in a clamp according to the present invention,
a cable passing through the series of pulleys, and wherein each pulley is removably attached to a cross member of the roman shade.

Preferably the pulleys connected via the cable form a linear array wherein the pulleys at either ends of the linear array have articulated pins, and the pulleys therebetween have fixed pins. This allows the shade fabric to move parallel with the ground when the cord is pulled tight.

Other aspects and preferred forms are disclosed in the specification and/or defined in the appended claims, forming a part of the description of the invention.

In essence, embodiments of the present invention stem from the realization that the means by which the clamp is attached to a connector, such as a pulley, is important to the function of the connector. In particular anchoring the connector within the clamp affects the operation of the pulley system and roman shade to which it may be attached.

Advantages provided by the present invention when used with a retractable roman shade comprise the following:
arrangement of single and dual arms allows neat stacking of adjacent cross-members and clamps when the roman shade is retracted,
the pulley is anchored in position yet still has a desired degree of movement, such as, being able to sway side to side, as the shade moves in the wind,
the pulley is anchored in position yet is still able to swivel and move slightly left or right if the shade does not retract in a perfectly straight line,
the clamp does not pierce the shade fabric or aluminium poles,
the clamp is removable and can be readily repositioned without damaging the fabric or cross member, and can be adjusted to fit a range of cross-member sizes,
the clamp can be used in roman shade systems suitable for DIY assembly and is not limited to factory manufacture and custom installation via a limited number of installers,
the system simplifies and de-risks the roman shade installation process, thus allowing the user to install the clamps and pulleys without irreversible damage if mistakes are made; and
the clamp applies balanced/centred force and reduces the risk of movement or destabilisation during operation of the roman shade, or when the shade is subjected to movement in the wind.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a prior art arrangement for connection of a roman shade to a pulley;

FIG. 2 illustrates in perspective view, a clamp according to the present invention attached to a pulley;

FIG. 3 illustrates the clamp and pulley of FIG. 2 in side view;

FIG. 4 illustrates the clamp and pulley of FIG. 2 viewed from the front and underneath;

FIG. 5 illustrates the clamp of FIG. 2 without the pulley;

FIG. 6 illustrates a system according to the present invention comprising a pulley system with pulleys anchored to clamps according to the present invention, which are attached to cross-members of a roman shade;

FIG. 7 illustrates a roman shade and a system according to the present invention;

FIGS. 8A and 8B illustrate two embodiments of a connector in the form of the pulley used in a clamp of the present invention;

FIGS. 9A and 9B illustrate another embodiment of a connector (FIG. 9A) in the form of a Y-shackle used in a clamp (FIG. 9B) of the present invention.

### LIST OF PARTS

The numbering for the illustrations listed above is set out in the following Table:

| | | | |
|---|---|---|---|
| 1 | Roman shade | 3 | Shade fabric |
| 5 | Cable of pulley system | 7 | Pulleys (prior art) |
| 9 | Cross-members | 11 | Metal ring |
| 13 | Steel saddle | 15 | Rivets |
| 17 | Clamp | 19 | Pulley |
| 21 | Clamp body | 21A | Exterior surface |
| 21B | Interior surface | 23 | First anterior arm |
| 25 | Second anterior arm | 27 | Posterior arm |
| 29 | Screw or locking pin | 31 | Axle pivot |
| 33 | Screw holes | 35 | Conduit/recess in clamp |
| | | | body |
| 37 | Pivot point of pulley | 39 | Recess in pulley pin |
| 40 | Pulley pin | | |
| 41 | Eye bolt | 45 | Y-shackle |
| 47 | Y-shackle pin | 49 | Recess in Y-shackle pin |

### DETAILED DESCRIPTION

For purposes of description herein, the terms “upper,” “lower,” “right,” “left,” “rear,” “front,” “vertical,” “horizontal,” “interior,” “exterior,” and derivatives thereof shall relate to the invention oriented as indicated by the axes depicted in the FIGs. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature or component extending in or along a given direction or the like does not mean that the feature or component follows a straight line or axis in such a direction or that it only extends in such direction or on such a plane without other directional components or deviations, unless otherwise specified.

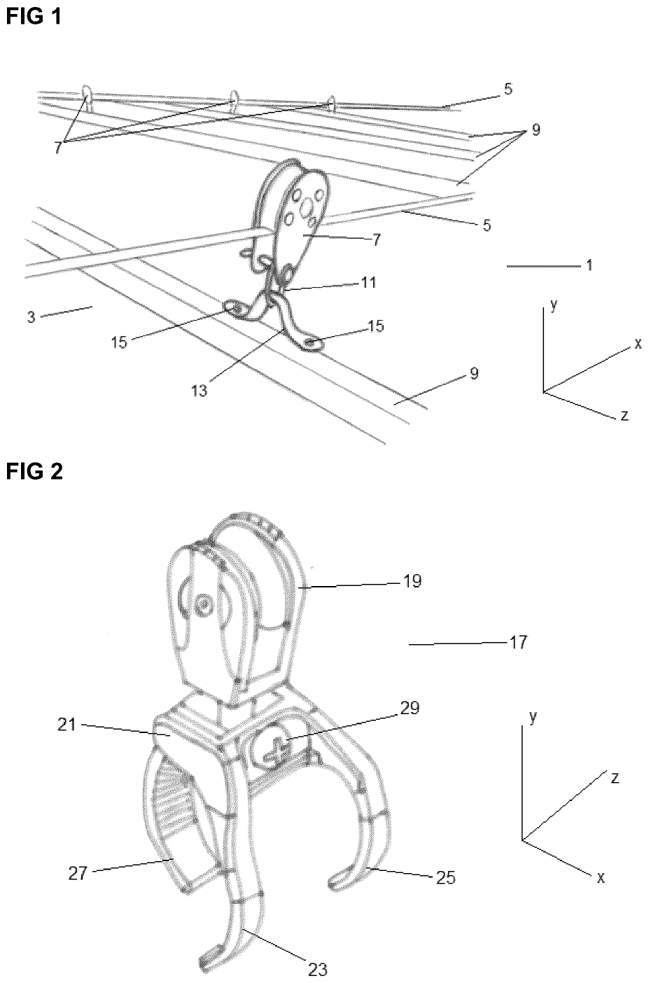

FIG. 1 depicts a system of the prior art for connecting the pulleys to the cross-members of roman shades. The retractable roman shade 1 comprises one or more pieces of fabric 3 attached to a cable 5 of a pulley system. The cable may be of any convenient type such as a thin flexible stainless steel wire cable and in this illustration is seen extending in the x-direction. The cable 5 and pulley system extends along the fabric 3, which also extends in the x-direction. The cables and pulleys are typically located at a set distance apart that corresponds to about 60% of the shade width as this allows the distribution of weight of the shade and cross members. The cable 5 is threaded through individual pulleys 7 attached to elongate cross-members 9 that are located periodically along the length of the fabric 3 and extend in the z-direction. The elongate cross-members 9 in this embodiment are strong, light weight tubes of aluminium or carbon fibre stitched into channels formed across the fabric 3.

The pulley 7 is connected via a metal ring 11 to a stainless steel saddle 13 held by two rivets 15 to the cross-member 9.

FIG. 2 illustrates in perspective view, a clamp 17 according to the present invention removably anchored to a pulley 19. The clamp 17 comprises a clamp body 21 integral with a curved first anterior arm 23 and a curved second anterior arm 25. A posterior third arm 27 is pivotably articulated relative to the clamp body 21. A screw or locking pin 29 passes through the clamp body 21 to secure the posterior arm 27 in place relative to the first anterior arm 23 and second 25 anterior arm. By tightening/loosening the screw or locking pin 29 in the clamp body 21, the clamping force between the posterior and anterior arms can be increased/decreased. It will be appreciated that there are other forms of adjuster or adjustment device that would be suitable for changing the degree of clamping force between the arms.

The screw or locking pin 29 also passes through a pin (not visible) that is integral with the pulley 19 and thereby removably anchors the pulley 19 to the clamp 17.

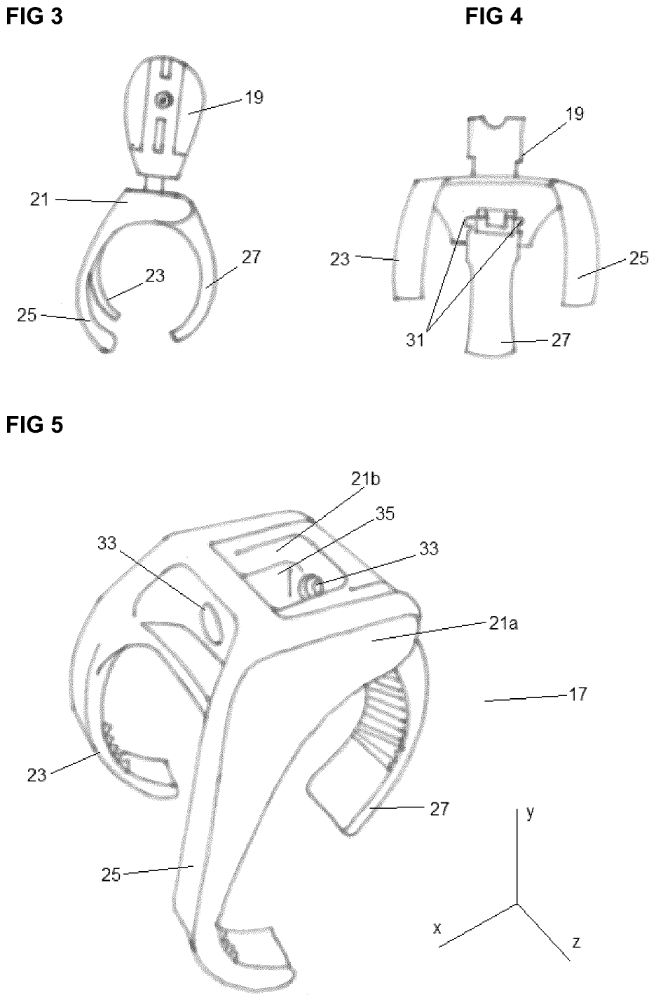

FIG. 3 illustrates the clamp 17 and pulley 19 of FIG. 2 in side view (viewed in the z-direction). In this view it is possible to see that the clamp body 21 is integral with the first anterior arm 23 and second 25 anterior arm which curve in a first direction while the posterior arm 27 has an opposing curve.

FIG. 4 illustrates the clamp 17 viewed from the front and underneath. In this view it is possible to see the ends of an axle 31 about which the posterior arm 31 can pivot. It will be appreciated that many different types of articulation, including many different pivot arrangements would be suitable for moving the posterior arm 27 relative to the clamp body 21.

FIG. 5 illustrates the clamp 17 solus, without a pulley attached. This view shows the clamp body 21 which is generally rectangular in shape and has an external surface 21a. The clamp body 21 has an internal surface 21b that defines a generally rectangular conduit 35 or recess in the clamp body 21. The body further includes recesses in the form of screw or locking pin holes 33 for receiving the screw or locking pin 29 in the x-direction, one of which is threaded. The clamp body 21 is integral with the first anterior arm 23 and second 25 anterior arm, and pivotally attached to the posterior arm 27. When viewed in the x-direction, the posterior arm 27 is generally convex in shape and the first anterior arm 23 and second anterior arm 25 are generally concave in shape.

In use, the cross-member of a roman shade would be located in the z-direction. The first anterior arm 23 and second anterior arm 25 would be wrapped around one side of the cross-member while the posterior arm 27 would be wrapped around the other side such that the three arms at least partially encircle the cross-member. A screw or locking pin 29 inserted in the recesses can be tightened against the clamp body 21 or a screw, causing the posterior arm to move around the pivot 31 to firmly grip and retain the cross-member.

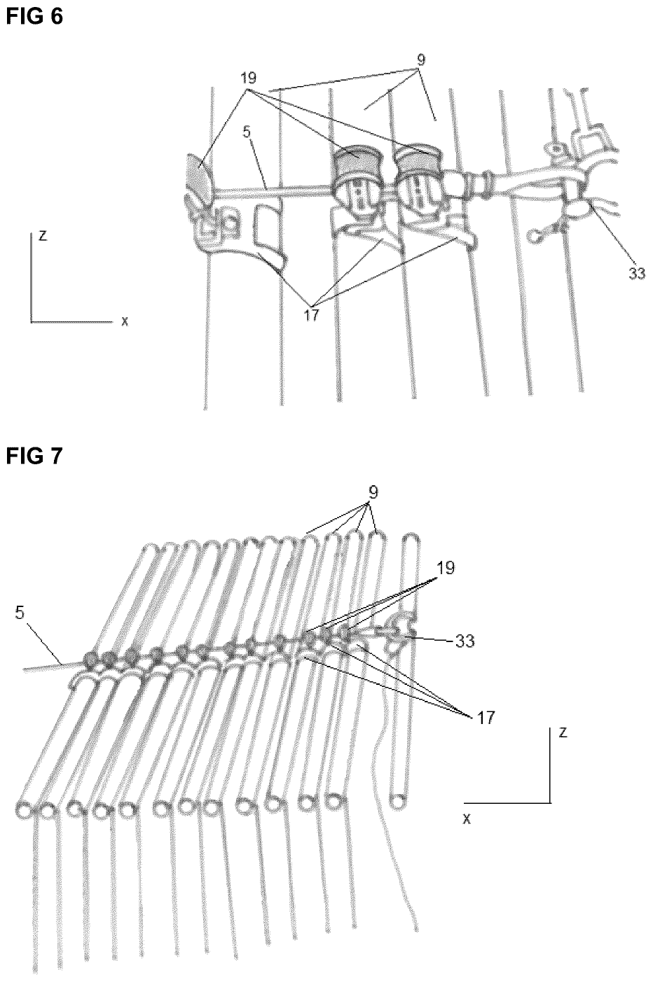

FIG. 6 depicts part of a system according to the present invention for a roman shade 1. In this view clamps 17 according to the present invention are attached to cross-members 9 of a roman shade 1, the posterior and anterior arms of each clamp wrapping around a cross-member. Each clamp is associated with a pulley 19 and cable 5, which in this view can be seen anchored at its looped end to an eye bolt 33 that is securely fastened to a support structure. In a particularly preferred embodiment, a fork terminal with cables swaged inside attaches to the eye bolt on the structure via the fork terminal head.

FIG. 7 is a wider view of the system and the roman shade 1 of FIG. 6. The system comprises a series of pulleys 19, each pulley being respectively anchored in a clamp 17 with a cable 5 passing sequentially through each pulley 19. Each pulley 19 is removably attached to a cross member 9 of the roman shade. One end of the cable 5 is attached to an eye bolt 41 secured to a fixture such as a wall or other structure. This view illustrates how the cross members 9 can be neatly stacked in close alignment when the shade fabric has been retracted by the pulley system.

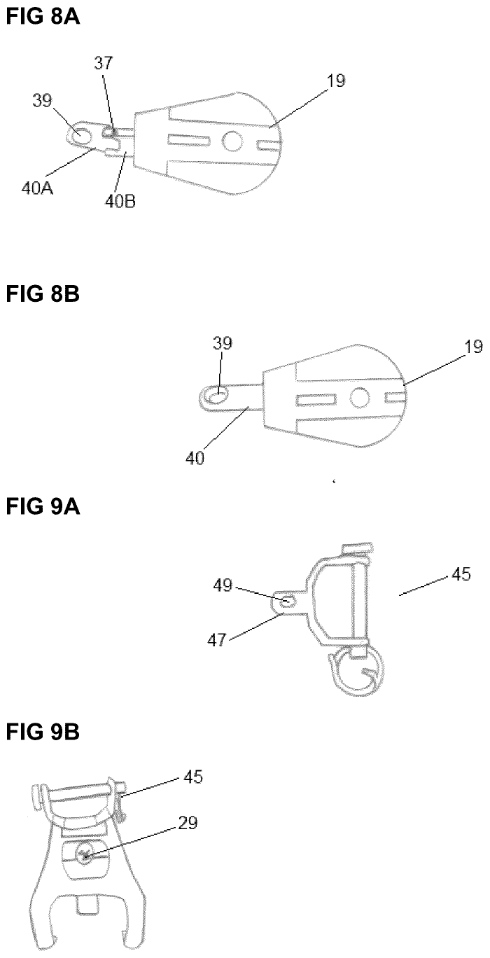

FIGS. 8A and 8B illustrate connectors in the form of pulleys 19 of a preferred configuration for use in the present invention. Typically, the pulley 19 includes a pin 40 that is integral with the pulley 19 and can be located in the conduit in the clamp body 21. In this embodiment the pin 40 has a recess 39 for receiving the screw or locking pin 29. The pin 40 may be fixed and integral with the pulley 19 as illustrated in FIG. 8B, or the pin 40 may comprise a first pin part 40B which is pivotally articulated relative to a second pin part 40A about a pivot point 37 as illustrated in FIG. 8A.

In the system of the present invention, preferably the pulleys 19 connected via the cable 5 form a linear array wherein the pulleys 19 at either ends of the linear array have articulated pins such as depicted in FIG. 8A, and the pulleys 19 therebetween have fixed pins such as depicted in FIG. 8B. This allows the shade fabric to move parallel with the ground when the cable is pulled tight.

The system of the present invention can be assembled on-site in DIY fashion and does not require ‘off site’ production by a manufacturer. The system is also suited to be adapted and modified according to the needs encountered ‘on-site’ and is flexible with respect to cable positioning or other requirements. The system is also forgiving with respect to the user because they can alter the position of the clamps without the risk of making an irreversible mistake that damages the shade fabric and cross members. Shade systems from manufacturers are often difficult to assemble, requiring the expense of trained installers, and incurring the high costs associated with shipping the system components from the manufacturer to the installation location.

FIG. 9A illustrates another type of connector suitable for use with the clamp of the present invention. FIG. 9B illustrates the connector located in a clamp according to the present invention. In this embodiment the connector is a Y-shackle 45 that includes a pin 47 that is integral with the shackle 45 and can be located in the conduit in the clamp body 21. In this embodiment the pin 47 has a recess 49 for receiving the screw or locking pin 29 of the clamp.

The Y-shackle 45 may for example, be attached to the operating cord (loop of polyester cord) that is connected in the centre of the lead cross member. The Y-shackle may also be used for attaching stacking clamps to the fixed end of the roman shade so that when the shade is being extended, the fabric will be taut when the shade is fully extended.

While this invention has been described in connection with specific embodiments thereof, it will be understood that it is capable of further modification(s). This application is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The broad term “comprising” is intended to encompass the narrower “consisting essentially of” and the even narrower “consisting of.” Thus, in any recitation herein of a phrase “comprising one or more claim element” (e.g., “comprising A”), the phrase is intended to encompass the narrower, for example, “consisting essentially of A” and “consisting of A”. Thus, the broader word “comprising” is intended to provide specific support in each use herein for either “consisting essentially of” or “consisting of”. The invention illustratively described herein suitably may be practiced in the absence of any element or elements, limitation or limitations which is not specifically disclosed herein.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

Each reference cited herein is incorporated by reference herein in their entirety. Such references may provide sources of materials; alternative materials, details of methods, as well as additional uses of the invention.

1. An adjustable clamp adapted for anchoring a connector, the clamp having a clamp body and opposed curved arms, at least one of the curved arms being articulated relative to the clamp body.

2. An adjustable clamp according to claim 1 comprising a first curved arm and a second, opposed curved arm that is articulated relative to the clamp body.

3. An adjustable clamp according to claim 1 comprising two curved arms and a third, opposed curved arm that is articulated relative to the clamp body.

4. An adjustable clamp according to claim 1 comprising a recess adapted to releasably retain at least part of a connector.

5. An adjustable clamp according to claim 4 wherein the connector is a pulley or shackle.

6. A clamp for removably retaining a cross-member of a retractable shade, the clamp having;
a clamp body comprising at least one curved arm, and at least one opposing curved arm which is articulated relative to the clamp body, and a recess for releasably retaining a connector, and
an adjuster for applying clamping force between the at least one curved arm and the at least one opposing curved to clamp the cross member and anchor the connector to the cross member.

7. A clamp according to claim 6 wherein the connector is a pulley or shackle.

8. A clamp for retaining the cross-member of a retractable shade, the clamp comprising;
a clamp body comprising two integral anterior curved arms, and an articulated posterior arm, the clamp body defining a conduit for receiving at least part of a connector, and
an adjuster for applying clamping force between the anterior arms and posterior arm, the adjuster passing through the clamp body and through at least part of the connector and traversing the conduit.

9. A clamp according to claim 8 wherein the connector is a pulley or a shackle.

10. A pulley system for a roman shade, the system comprising;
a series of pulleys,
a cable passing through the series of pulleys,
wherein each pulley is retained in a respective clamp of claim 1, and is thus anchored to a cross member of the roman shade.

11. A pulley system for a roman shade, the system comprising;
a series of pulleys,
a cable passing through the series of pulleys,
wherein each pulley is retained in a respective clamp of claim 6, and is thus anchored to a cross member of the roman shade.
